(19) United States
(12) Patent Application Publication
(10) Pub. No.: US 2010/0082747 A1
(43) Pub. Date: Apr. 1, 2010

(54) REAL-TIME COLLABORATIVE BROWSING

(75) Inventors: Chuan YUE, Hampton, VA (US); Haining WANG, Vienna, VA (US)

Correspondence Address: FOLEY AND LARDNER LLP;SUITE 500, 3000 K STREET NW, WASHINGTON, DC, 20007, US

(73) Assignee: COLLEGE OF WILLIAM & MARY

(21) Appl. No.: 12/567,295

(22) Filed: Sep. 25, 2009

Related U.S. Application Data
(60) Provisional application No. 61/100,832, filed on Sep. 29, 2008.

(51) Int. Cl. G06F 3/01; G06F 15/16

(52) U.S. Cl. 709/204; 715/753; 709/227

(57) ABSTRACT

A method, a system, and a computer-readable medium are provided which support a collaborative browsing session. A connection request is received at a first device from a second device. The connection request indicates a request for a collaborative browsing session between the first device and the second device. In response to the connection request, a web page is sent to the second device from the first device. The web page includes embedded computer-executable instructions to support the collaborative browsing session. A browser application at the first device is monitored for a change in state. An indicator of the change in state of the browser application is sent to the second device from the first device.

### CROSS-REFERENCE TO RELATED APPLICATIONS

The present application claims priority to U.S. Provisional Patent Application Ser. No. 61/100,832, filed on Sep. 29, 2008, and titled “METHOD FOR REAL-TIME COLLABORATIVE BROWSING,” the disclosure of which is incorporated herein by reference in its entirety.

### BACKGROUND

At present, various soft real-time applications are widely used in the Internet. For example, voice streams can be delivered to end-users via IP telephony systems, which support real-time audio communication, while real-time text-based communication can be achieved by using instant messaging systems providing live chat support. One of the key features of these soft, real-time applications is that multiple users interactively communicate with each other in real time.

Despite being one of the most popular Internet activities, however, web browsing using a browser application is still an isolated task. In other words, browsing is still a process that is mainly between a user at a client computer and a remote web server, and there is little real-time interaction between different users who are simultaneously visiting the same web pages.

Collaborative browsing, also known as co-browsing, is the technique that allows multiple users to browse the same web pages in a simultaneous manner, and collaboratively fulfill certain tasks. Co-browsing has a wide range of important applications. For example, school instructors can illustrate online materials to distance learning students, business representatives can provide live online technical support to their clients, and regular web users can conduct online shopping with their friends.

Various approaches to achieve different levels of co-browsing have been proposed. At one extreme, rudimentary co-browsing can be performed by simply sharing a uniform resource locator (URL) in a browser application's address bar via an instant message. This solution is lightweight, and only enables very limited collaboration on a narrow scope of web pages. Collaboration is limited since users can view web pages, but cannot perform many useful activities such as co-filling of online forms or synchronizing mouse-pointer actions. Web pages eligible for this simple co-browsing method are also limited because: (1) most session-protected web pages cannot be accessed by simply copying the URLs, and (2) there are many dynamically-updated web pages (e.g., Google Maps), where the retrieved contents will be different even with the same URL. At the other extreme, fully functional co-browsing can be achieved via screen-sharing or application-sharing software. However, these approaches are cumbersome. To enable useful co-browsing activities, they must grant the control of a whole screen or a whole application to remote users, which may cause serious security and privacy concerns. Moreover, they place high demands on network bandwidth. Therefore, their usage is very limited.

To support fully functional co-browsing with moderate overhead, a number of techniques have been developed. Based on their high-level architectures, these techniques can be classified into three categories: platform-based, server-based, and proxy-based. The platform-based solutions heavily depend on the wide deployment of collaborative platforms. The server-based solutions only apply to a few web sites whose hosting servers are intentionally modified to support collaborative browsing. The proxy-based solutions need compelling incentives from organizations to deploy and require users to have sufficient trust. These drawbacks seriously impede the wide use of co-browsing over the Internet.

### SUMMARY

In an example embodiment, a method for supporting a collaborative browsing session is provided. A connection request is received at a first device from a second device. The connection request indicates a request for a collaborative browsing session between the first device and the second device. In response to the connection request, a web page is sent to the second device from the first device. The web page includes embedded computer-executable instructions to support the collaborative browsing session. A browser application at the first device is monitored for a change in state. An indicator of the change in state of the browser application is sent to the second device from the first device.

In another example embodiment, a computer-readable medium is provided having stored thereon computer-readable instructions that, if executed by a computing device, cause the computing device to perform the method of supporting a collaborative browsing session.

In yet another example embodiment, a system is provided. The system includes, but is not limited to, a processor and the computer-readable medium operably coupled to the processor. The computer-readable medium has instructions stored thereon that, if executed by the processor, cause the system to perform the method of supporting a collaborative browsing session.

Other principal features and advantages of the invention will become apparent to those skilled in the art upon review of the following drawings, the detailed description, and the appended claims.

### BRIEF DESCRIPTION OF THE DRAWINGS

Example embodiments will hereafter be described with reference to the accompanying drawings, wherein like numerals denote like elements.

FIG. 1 depicts a block diagram of a host browser device in accordance with an example embodiment.

FIG. 2 depicts a block diagram of a co-browser device in accordance with an example embodiment.

FIG. 3 depicts a block diagram of a collaborative browsing system in accordance with an example embodiment.

FIG. 4 depicts a flow diagram illustrating example operations performed by the host browser device of FIG. 1 in accordance with an example embodiment.

FIG. 5 depicts a flow diagram illustrating example operations performed by the co-browser device of FIG. 2 in accordance with an example embodiment.

FIG. 6 depicts a schematic diagram showing an architecture of the collaborative browsing system of FIG. 3 in accordance with an example embodiment.

FIG. 7 depicts a flow diagram illustrating example operations performed as part of a request processing procedure in accordance with an example embodiment.

FIG. 8 depicts a flow diagram illustrating example operations performed as part of a document content change check procedure in accordance with an example embodiment.

FIG. 9 depicts a sample of a new content data block in accordance with an example embodiment.

FIG. 10 depicts a flow diagram illustrating example operations performed as part of a request response processing procedure in accordance with an example embodiment.

### DETAILED DESCRIPTION

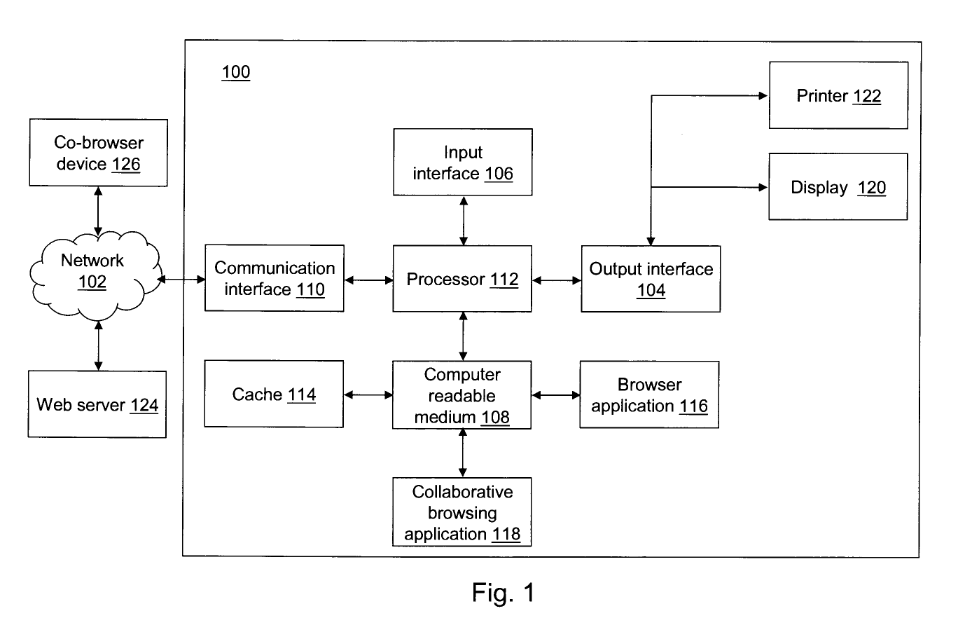

With reference to FIG. 1, a block diagram of a host browser device 100 is shown in accordance with an example embodiment. Host browser device 100 may include an output interface 104, an input interface 106, a computer-readable medium 108, a communication interface 110, a processor 112, a cache 114, a browser application 116, a collaborative browsing application 118, a display 120, and a printer 122. Host browser device 100 may be a computer of any form factor. Different and additional components may be incorporated into host browser device 100.

In the embodiment illustrated in FIG. 1, communication interface 110 of host browser device 100 supports communication with a web server 124 and a co-browser device 126 using a network 102. Network 102 can be any type of wired and/or wireless public or private network including a local area network and a wide area network such as the Internet. Network 102 further may be comprised of sub-networks and consist of any number of devices.

Web server 124 may be a computer of any form factor that executes a computer program configured to accept hypertext transport protocol (HTTP) requests from client devices such as host browser device 100 and/or co-browser device 126 and to send HTTP responses along with optional additional data content which may include web pages such as hypertext markup language (HTML) documents and linked objects in response to the HTTP requests. Web server 124 may provide information or data organized in the form of a website accessible over network 102. A website may comprise multiple web pages that display a specific set of information and may contain hyperlinks to other web pages with related or additional information.

Each web page is identified by a uniform resource locator (URL) that includes the location or address of the computing device that contains the resource to be accessed in addition to the location of the resource on that computing device. The type of file or resource depends on the Internet application protocol. For example, HTTP and HTTP secure (HTTPS) describe a web page to be accessed with browser application 116. The file accessed may be a simple text file, an image file, an audio file, a video file, an executable, a common gateway interface application, a Java applet, or any other type of file supported by HTTP.

Output interface 104 provides an interface for outputting information for review by a user of host browser device 100. For example, output interface 104 may include an interface to display 120, printer 122, a speaker (not shown), etc. Display 120 may be a thin film transistor display, a light emitting diode display, a liquid crystal display, or any of a variety of different displays known to those skilled in the art. Printer 122 may be any of a variety of printers as known to those skilled in the art. The speaker may be any of a variety of speakers as known to those skilled in the art. Host browser device 100 may have one or more output interfaces that use the same or a different interface technology. Display 120 and/or printer 122 further may be accessible to host browser device 100 through communication interface 110.

Input interface 106 provides an interface for receiving information from the user for entry into host browser device 100 as known to those skilled in the art. Input interface 106 may use various input technologies including, but not limited to, a keyboard, a pen and touch screen, a mouse, a track ball, a touch screen, a keypad, one or more buttons, etc. to allow the user to enter information into host browser device 100 or to make selections presented in a user interface displayed on display 120. Input interface 106 may provide both an input and an output interface. For example, a touch screen both allows user input and presents output to the user. Host browser device 100 may have one or more input interfaces that use the same or a different input interface technology.

Computer-readable medium 108 is an electronic holding place or storage for information so that the information can be accessed by processor 112 as known to those skilled in the art. Computer-readable medium 108 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., CD, DVD, . . . ), smart cards, flash memory devices, etc. Host browser device 100 may have one or more computer-readable media that use the same or a different memory media technology. Host browser device 100 also may have one or more drives that support the loading of a memory media such as a CD or DVD. Computer-readable medium 108 may comprise cache 114 in which data can be stored temporarily for rapid access by processor 112.

Communication interface 110 provides an interface for receiving and transmitting data between devices using various protocols, transmission technologies, and media as known to those skilled in the art. The communication interface may support communication using various transmission media that may be wired or wireless. Host browser device 100 may have one or more communication interfaces that use the same or a different communication interface technology. Data may be transferred between host browser device 100 and web server 124 and/or co-browser device 126 using communication interface 110.

Processor 112 executes instructions as known to those skilled in the art. The instructions may be carried out by a special purpose computer, logic circuits, or hardware circuits. Thus, processor 112 may be implemented in hardware, firmware, software, or any combination of these methods. The term “execution” is the process of running an application or the carrying out of the operation called for by an instruction. The instructions may be written using one or more programming language, scripting language, assembly language, etc. Processor 112 executes an instruction, meaning that it performs the operations called for by that instruction. Processor 112 operably couples with output interface 104, with input interface 106, with computer-readable medium 108, and with communication interface 110 to receive, to send, and to process information. Processor 112 may retrieve a set of instructions from a permanent memory device and copy the instructions in an executable form to a temporary memory device that is generally some form of RAM. Host browser device 100 may include a plurality of processors that use the same or a different processing technology.

Browser application 116 performs operations associated with retrieving, presenting, and traversing information resources provided by web server 124 using network 102 as known to those skilled in the art. An information resource is identified by a uniform resource identifier (URI) and may be a web page, image, video, or other piece of content. Hyperlinks in resources enable users to navigate to related resources. Example browser applications 116 include Navigator by Netscape Communications Corporation, Firefox by Mozilla Corporation, Opera by Opera Software Corporation, Internet Explorer by Microsoft Corporation, Safari by Apple Inc., Chrome by Google Inc., etc. as known to those skilled in the art.

Collaborative browsing application 118 performs operations associated with collaborative browsing between a user of host browser device 100 and a second user of co-browser device 126. Some or all of the operations described herein may be embodied in collaborative browsing application 118. The operations may be implemented using hardware, firmware, software, or any combination of these methods. With reference to the example embodiment of FIG. 1, collaborative browsing application 118 is implemented in software (computer-executable instructions) stored in computer-readable medium 108 and accessible by processor 112 for execution of the instructions that embody the operations of collaborative browsing application 118. Collaborative browsing application 118 may be written using one or more programming languages, assembly languages, scripting languages, etc. Collaborative browsing application 118 may be implemented as a plug-in integrated into browser application 116. In an example embodiment, collaborative browsing application 118 is written using JavaScript.

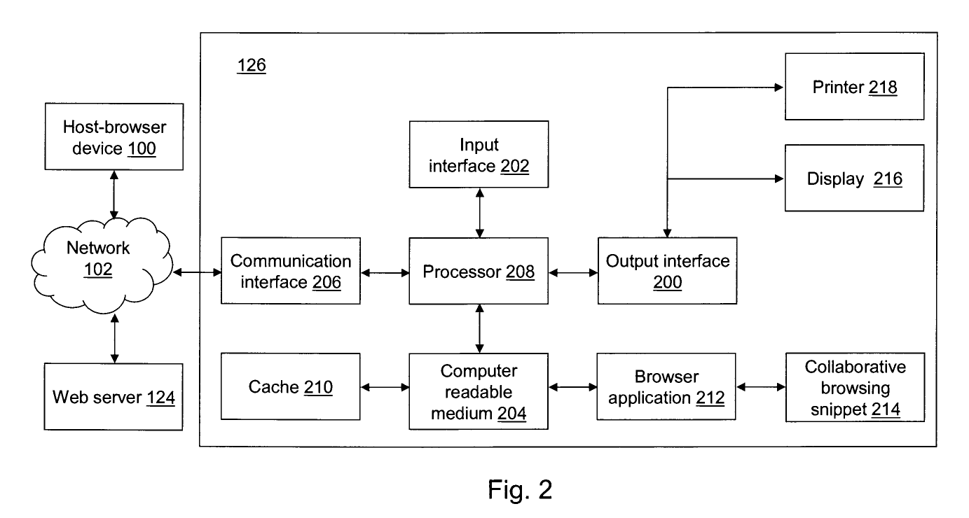

With reference to FIG. 2, a block diagram of co-browser device 126 is shown in accordance with an example embodiment. Co-browser device 126 may include a second output interface 200, a second input interface 202, a second computer-readable medium 204, a second communication interface 206, a second processor 208, a second cache 210, a second browser application 212, a collaborative browsing snippet 214, a second display 216, and a second printer 218. Co-browser device 126 may be a computer of any form factor. Different and additional components may be incorporated into co-browser device 126. The same computing device may act as co-browser device 126 and/or host browser device 100. If the same computing device is acting as co-browser device 126 and/or host browser device 100, the computing device includes collaborative browsing application 118 and collaborative browsing snippet 214.

Second output interface 200 provides the same or similar functionality as that described with reference to output interface 104 of host browser device 100. Second input interface 202 provides the same or similar functionality as that described with reference to input interface 106 of host browser device 100. Second computer-readable medium 204 provides the same or similar functionality as that described with reference to computer-readable medium 108 of host browser device 100. Second communication interface 206 provides the same or similar functionality as that described with reference to communication interface 110 of host browser device 100. Second processor 208 provides the same or similar functionality as that described with reference to processor 112 of host browser device 100. Second processor 208 operably couples with second output interface 200, with second input interface 202, with second computer-readable medium 204, and with second communication interface 206 to receive, to send, and to process information. Second cache 210 provides temporary data storage for rapid access by second processor 208. Second browser application 212 provides the same or similar functionality as that described with reference to browser application 116 of host browser device 100. Second browser application 212 and browser application 116 may be the same or different browser applications.

Collaborative browsing snippet 214 performs operations associated with collaborative browsing between the second user of co-browser device 126 and the user of host browser device 100. Some or all of the operations described herein may be embodied in collaborative browsing snippet 214. The operations may be implemented using hardware, firmware, software, or any combination of these methods. With reference to the example embodiment of FIG. 2, collaborative browsing snippet 214 is implemented in software (computer-executable instructions) stored in second computer-readable medium 204 and accessible by second processor 208 for execution of the instructions that embody the operations of collaborative browsing snippet 214. Collaborative browsing snippet 214 may be written using one or more programming languages, assembly languages, scripting languages, etc. Collaborative browsing snippet 214 may be implemented using asynchronous JavaScript and extensible markup language (XML) (AJAX) and embedded in an HTML page downloaded to co-browser device 126, for example, from host browser device 100. Collaborative browsing snippet 214 may be installed and executed within an HTML-based web page without requiring additional compilation. Collaborative browsing snippet 214 may be written in JavaScript.

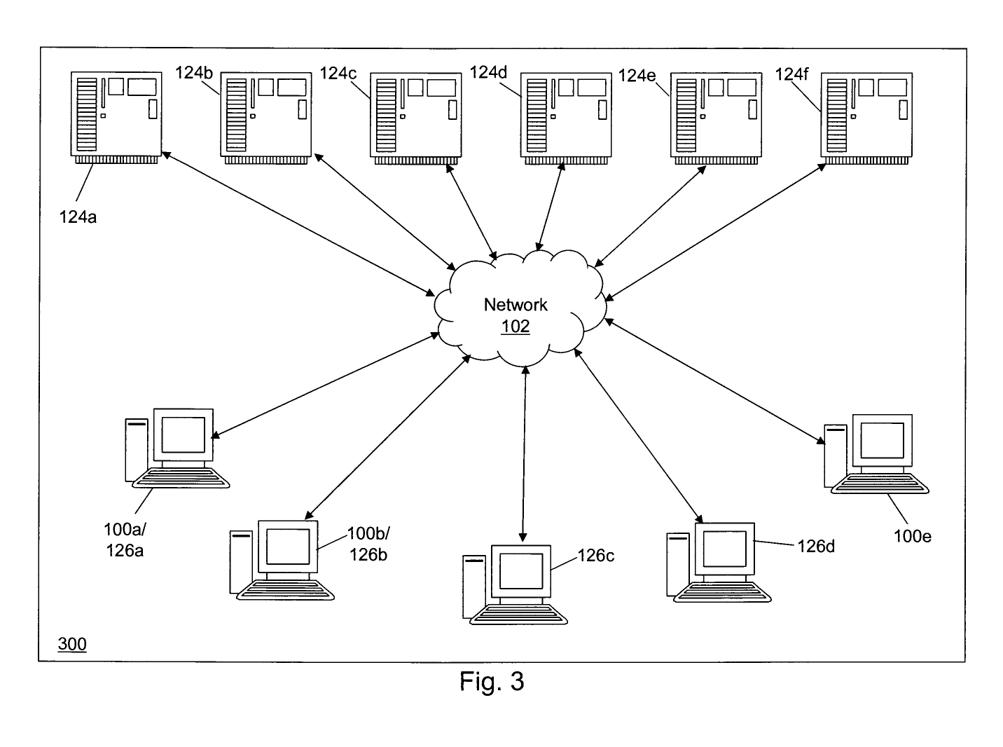

A co-browsing system may include any number of web servers and any number of host browser devices and/or co-browser devices. With reference to FIG. 3, a co-browsing system 300 is shown in accordance with an example embodiment. In the example shown with reference to FIG. 3, co-browsing system 300 includes a first host browser/co-browser device 100a/126a, a second host browser/co-browser device 100b/126b, a third co-browser device 126c, a fourth co-browser device 126d, and a fifth host browser device 100e. A user can host a co-browsing session while, at the same time, joining sessions hosted by other users. Thus, as an example, a user at first host browser/co-browser device 100a/126a can host a co-browsing session with fourth co-browser device 126d while participating as a co-browser in a co-browsing session hosted by second host browser/co-browser device 100b/126b. A user at second host browser/co-browser device 100b/126b can host a co-browsing session with third co-browser device 126c while participating as a co-browser in the co-browsing session hosted by first host browser/co-browser device 100a/126a. A user at fifth host browser device 100e can host a co-browsing session with third co-browser device 126c and fourth co-browser device 126d.

During a co-browsing session, the host browser/co-browser devices 100a/126a-100e/126e can access one or more web servers such as a first web server 124a, a second web server 124b, a third web server 124c, a fourth web server 124d, a fifth web server 124e, and a sixth web server 124f using network 102 without limitation. In an example embodiment, each user has full control over their hosted session in one browser window, while participating in the session hosted by another user in another browser window.

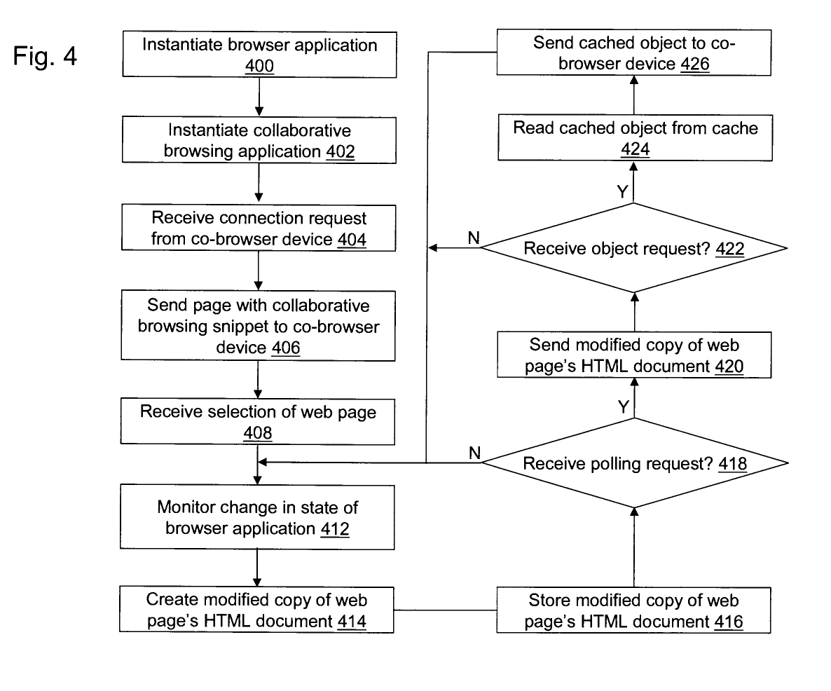

With reference to FIG. 4, example operations associated with browser application 116 and/or collaborative browsing application 118 of FIG. 1 are described. Additional, fewer, or different operations may be performed depending on the embodiment. The order of presentation of the operations of FIG. 4 is not intended to be limiting. In an operation 400, a browser application instance is instantiated at host browser device 100 by executing browser application 116. In an operation 402, a collaborative browsing instance is instantiated at host browser device 100 by executing collaborative browsing application 118 installed at host browser device 100 and an open transmission control protocol (TCP) port is associated with the collaborative browsing instance. In an operation 404, a connection request is received from co-browser device 126. In an operation 406, an HTML page is sent to co-browser device 126 which includes collaborative browsing snippet 214. For example, a “text/html” type of HTTP response with the content of a head element of the initial HTML page containing collaborative browsing snippet 214 is sent to co-browser device 126. In an operation 408, a selection of a web page is received. For example, the user of host browser device 100 enters a URL of the web page in an address window of browser application 116. Browser application 116 presents the selected web page in a user interface window of browser application 116. In an operation 412, browser application 116 is monitored for a change in state. A change in state of browser application 116 includes any change in the appearance of the web page presented in the user interface window of browser application 116 including scrolling, typing in a window, selecting an item presented in the user interface window, presenting a new window, etc. In an operation 414, a modified copy of the selected web page's HTML document is created. In an operation 416, the modified copy of the selected web page's HTML document is stored in computer-readable medium 108 and/or cache 114.

In an operation 418, a determination is made concerning whether or not a polling request is received from co-browser device 126. The determination may not be explicit. For example, receipt of a polling request may cause generation of an interrupt signal. If a polling request is not received from co-browser device 126, processing continues at operation 412. If a polling request is received from co- browser device 126, processing continues at an operation 420. In operation 420, the modified copy of the selected web page's HTML document is sent to co-browser device 126. In operation 422, a determination is made concerning whether or not an object request is received from co-browser device 126. The determination may not be explicit. For example, receipt of an object request may cause generation of an interrupt signal.

If an object request is not received from co-browser device 126, processing continues at operation 412. If an object request is received from co-browser device 126, processing continues at an operation 424. In operation 424, a cached object is identified and read from cache 114. In an operation 426, the cached object is sent to co-browser device 126 and processing continues at operation 412.

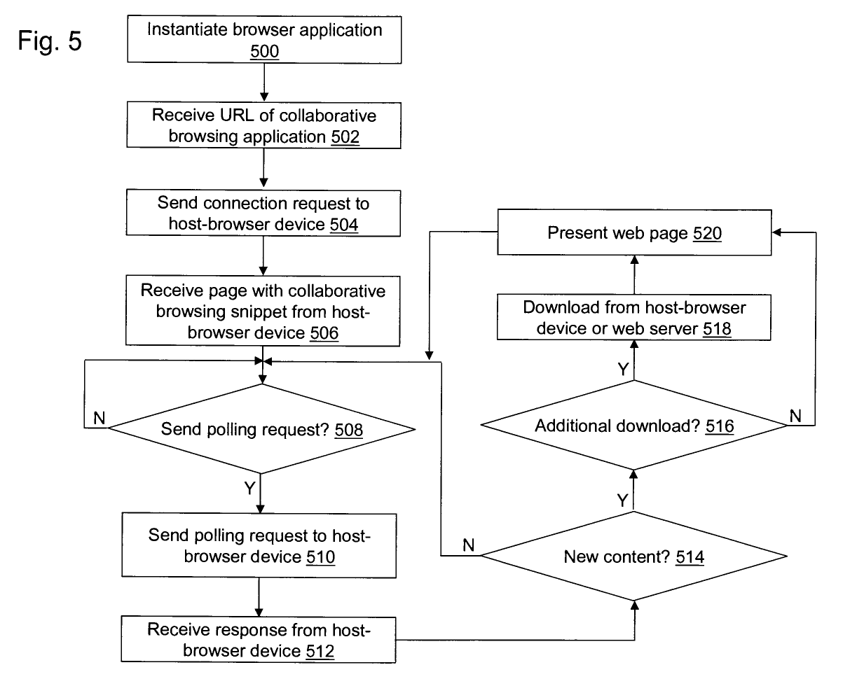

With reference to FIG. 5, example operations associated with second browser application 212 and/or collaborative browsing snippet 214 of FIG. 2 are described. Additional, fewer, or different operations may be performed depending on the embodiment. The order of presentation of the operations of FIG. 5 is not intended to be limiting. In an operation 500, a second browser application instance is instantiated at co-browser device 126 by executing second browser application 212. In an operation 502, a URL of collaborative browsing application 118 is received from a user by second browser application 212. For example, the user of co-browser device 126 enters the URL of collaborative browsing application 118 in a browser address window presented under control of second browser application 212. In an operation 504, a connection request is sent to collaborative browsing application 118 executing at host browser device 100. In an operation 506, an HTML page is received from host browser device 100. For example, the HTML page may include a head element containing collaborative browsing snippet 214 which is executed. In an operation 508, a determination is made concerning whether or not a polling request is to be sent to collaborative browsing application 118 executing at host browser device 100. If a polling request is not to be sent, processing continues at operation 508 until a polling request is to be sent. If a polling request is to be sent, processing continues at an operation 510.

In operation 510, a polling request is sent to host-browser device 100. In an operation 512, a response to the polling request is received from host-browser device 100. In an operation 514, a determination is made concerning whether or not new content is received in the response based on a change in state of browser application 116. If no new content is received, processing continues at operation 508. If new content is received, processing continues at an operation 516. In operation 516, a determination is made concerning whether or not additional information is to be downloaded. If additional information is to be downloaded, processing continues in an operation 518. If no additional information is to be downloaded, processing continues in an operation 520. In operation 518, the additional information is downloaded from host-browser device 100 or web server 124. In operation 520, the web page is presented in a user interface window under control of second browser application 212. Processing continues at operation 508.

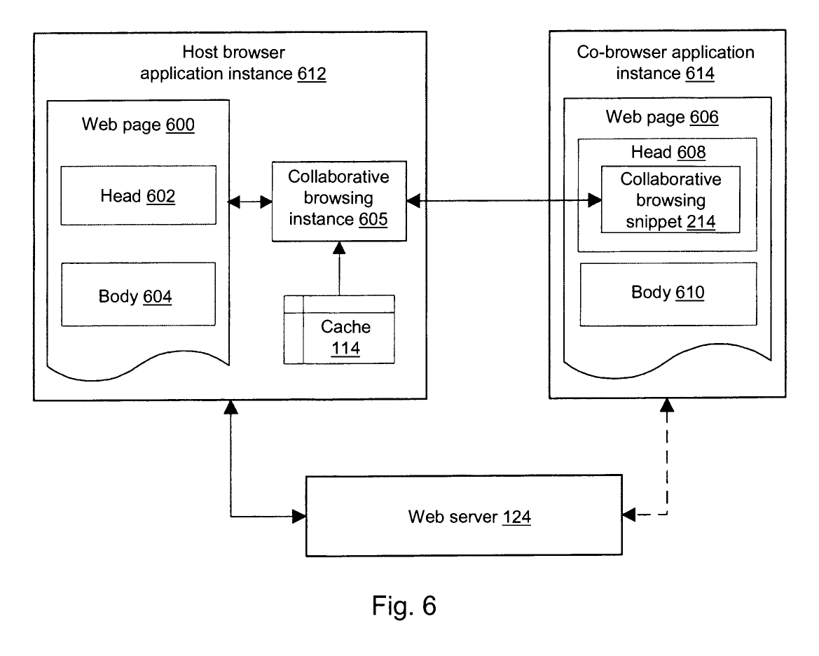

With reference to FIG. 6, the interaction between browser application 116 and second browser application 212 is shown in accordance with an example embodiment and as discussed with reference to FIGS. 4 and 5. First web page 600 presented in a host browser application instance 612 executing at host browser device 100 and second web page 606 presented in a co-browser application instance 614 executing at co-browser device 212 represent a currently co-browsed HTML page of a web site hosted by web server 124. The displayed content of each web page 600, 606 is the same on both browser application instances 612, 614, but the source code of each web page is different. First web page 600 includes a first head 602 and a first body 602. Second web page 606 is a modified copy of first web page 600 received from a collaborative browsing instance 605. Second web page 606 includes a second head 608 and a second body 610. Second head 608 includes collaborative browsing snippet 214.

To initiate the co-browsing session, the user of host browser device 100 installs collaborative browsing application 118 and executes collaborative browsing application 118 creating collaborative browsing instance 605 as part of host browser application instance 612 with an open TCP port (for example, port 3000). For example, the user executes browser application 116 that instantiates host browser application instance 612. The user selects an icon, button, etc. created by host browser application instance 612 and instantiates collaborative browsing instance 605 by executing collaborative browsing application 118 as a plug-in to browser application 116. The second user of co-browser device 126 types the URL address of the collaborative browsing instance 605 into an address window created under control of co-browser application instance 614 and sends a connection request to collaborative browsing instance 605 by selecting, for example, a “Go” button presented in the user interface window under control of co-browser application instance 614. An example URL address is “http://example-address:3000” where “example-address” is a reachable hostname or Internet protocol (IP) address. Collaborative browsing instance 605 responds to a valid request by returning the HTML page that contains collaborative browsing snippet 214. Collaborative browsing snippet 214 may periodically poll collaborative browsing instance 605, and a communication channel between host browser device 10 and co-browser device 126 is established.

In an example embodiment, a direct communication model supports collaboration between host browser device 100 and a co-browser device 126. Co-browser application instance 614 establishes a transport control protocol (TCP) connection to host browser device 100, without the support of a third-party platform, server, or proxy. If host browser device 100 has a resolvable hostname, the second user of co-browser device 126 specifies the hostname and an allowed TCP port to establish the communication channel. Port-forwarding techniques can be used to allow co-browser device 126 to reach host browser device 100 through a TCP port on a private IP address inside a local area network.

HTTP is a stateless protocol and the communication is initiated by a client. Since the HTTP protocol does not support the push-based synchronization model, poll-based synchronization emulates the effect of pushing web page content and information of user browsing activities between co-browsing users. In an alternate embodiment, web server 124 may use a “multipart/x-mixedreplace” type of response to emulate a content pushing effect instead of using poll-based synchronization.

Whenever the user of host browser device 100 visits a web page, collaborative browsing instance 605 monitors changes in the host browser's state and records file-downloading activities related to the web page in computer-readable medium 108 and/or cache 114. When the web page is loaded by host browser application instance 612, collaborative browsing instance 605 creates a copy of the web page's HTML document and makes necessary modifications to the copy. Upon receipt of a polling request, collaborative browsing instance 605 sends the content of the modified copy to co-browser application instance 614.

Collaborative browsing snippet 214 similarly monitors changes in the co-browser's state and records file-downloading activities related to the web page in computer-readable medium 204 and/or cache 210. When the web page is loaded by co-browser application instance 614, collaborative browsing snippet 214 creates a copy of the web page's HTML document and makes necessary modifications to the copy. The copy is sent in the next polling request to collaborative browsing instance 605.

Collaborative browsing snippet 214 analyzes the received content and replaces the corresponding HTML elements of the current page of co-browser application instance 614 in which collaborative browsing snippet 214 resides with the received content. In addition to the HTML document that describes the page structure, a web page may contain supplementary objects such as stylesheets, embedded images, and scripts. To accurately render the same web page, co-browser application instance 614 needs to download the supplementary objects of the web page. Based on the modifications in the copied HTML document, co-browser application instance 614 may download the supplementary objects either from the web server 124 or directly from cache 114.

Collaborative browsing instance 605 similarly analyzes the content received in a polling request and replaces the corresponding HTML elements of the current page of host browser application instance 612 with the received content.

Allowing co-browser application instance 614/host browser application instance 612 to directly download cached objects from cache 114/cache 210 provides at least two benefits. First, co-browser application instance 614/host browser application instance 612 does not need to have the capability to establish a network connection with web server 124. As an example, the connection between co-browser application instance 614 and web server 124 in FIG. 6 is represented as a dotted line. Second, if co-browser application instance 614 has a fast network connection with host browser application instance 612/collaborative browsing instance 605 (e.g., they are on the same network), directly downloading cached objects from host browser device 100 can reduce the response time in comparison to downloading them from the web server 124 via a slower link.

Dynamic changes happening in a co-browsed web page can be synchronized in real time between host browser application instance 612 and co-browser application instance 614. One user's (either a host user or a co-browser user) browsing actions such as scrolling, form filling, and mouse cursor movement can be monitored and mirrored to the other users. When the user at host browser device 100 visits a new web page, the operations 412-426 shown with reference to FIG. 4 are repeated. In a co-browsing session, users can visit different web sites and collaboratively browse as many web pages as they like before disconnecting to end the session.

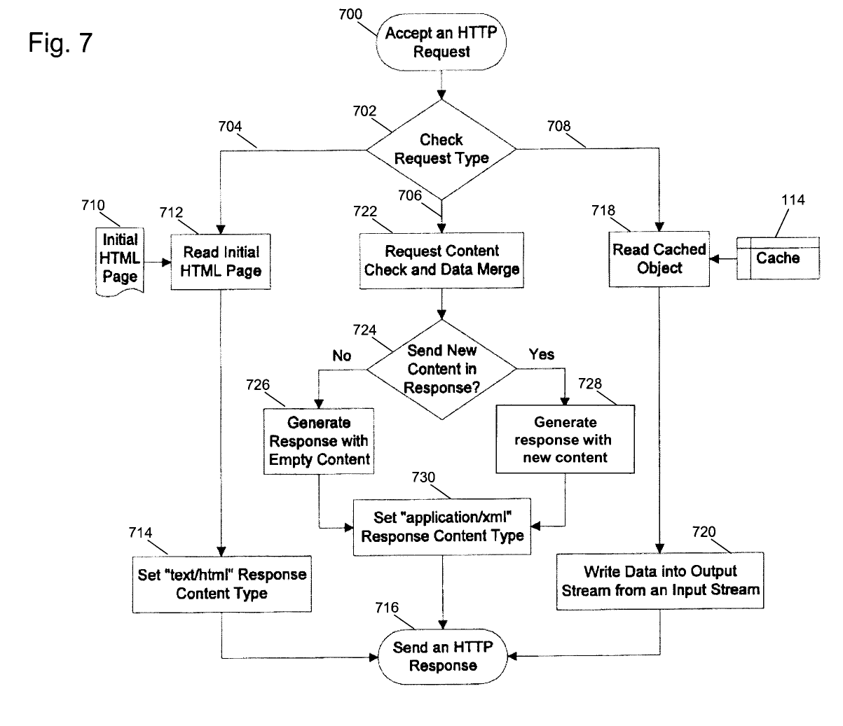

With reference to FIG. 7, example operations associated with a request processing procedure performed by browser application 116 and/or collaborative browsing application 118 of FIG. 1 are described. Additional, fewer, or different operations may be performed depending on the embodiment. The order of presentation of the operations of FIG. 7 is not intended to be limiting. In an example embodiment, the request processing functionality is implemented as a JavaScript object of Mozilla's nslServerSocket interface that provides methods to initialize a server socket object and maintain the server socket object in a listening state. In an example embodiment, for the server socket object, a socket listener object is created which implements the methods of Mozilla's nslServerSocketListener interface. The socket listener object is used to asynchronously listen for and accept client TCP connections. In an example embodiment, a data listener object is also created which implements Mozilla's nslStreamListener interface. The data listener object is associated with the input stream of each connected socket transport. Over each accepted TCP connection, collaborative browsing application 118 uses the data listener object to asynchronously accept and process incoming HTTP requests.

In an operation 700, an HTTP request is accepted. In an operation 702, a determination of which of three types of HTTP requests is determined: a new connection request 704, a polling request 706, or an object request 708. In an example embodiment, the type of HTTP request is identified by checking the method token and/or request-URI token in the request line of the HTTP request. New connection request 704 and object request 708 may use the “GET” method, but can be differentiated by their request-URI tokens. New connection request 704 may have a root URI. Object request 708 may have a URI that points to a specific resource such as an image file or a JavaScript file. Polling request 706 may use the “POST” method to add action information of a co-browsing participant onto polling request 706. New connection request 704 is sent to collaborative browsing application 118 after the URL of collaborative browsing application 118 is entered into the address window of co-browser application instance 614.

In an operation 712, in response to new connection request 704, an initial HTML page 710 is read from computer-readable medium 108 and/or cache 114. In an operation 714, a “text/html” type of HTTP response with the content of initial

HTML page 710 is sent to co-browser application instance 614. The head element of initial HTML page 710 contains collaborative browsing snippet 214.

An object request is sent to collaborative browsing application 118 if a cache mode is used to allow a co-browser device 126 to directly download a cached object from host browser device 100. In an example embodiment, host browser device 100 keeps a mapping table in which the request-URI of each cached object is mapped to a corresponding cache key. After obtaining the cache key for a request-URI, in an operation 718, the data of a cached object is read from cache 114 by creating a cache session via Mozilla's cache service. In an operation 720, the data is written directly from the input stream of the cached objects into the output stream of the connected socket transport.

A polling request is sent to collaborative browsing application 118 to check if any page content changes or browsing actions have occurred on host browser device 100. In an operation 722, the content of polling request 706 is examined and data is merged if the content of polling request 706 includes browsing action information of co-browser device 126. For example, if users are co-filling a form, the form data submitted by the second user of co-browser device 126 can be extracted and merged into the corresponding form on host browser device 100. In an operation 724, a determination is made concerning whether or not new content needs to be sent back to co-browser device 126.

In an example embodiment, a timestamp mechanism is used to ensure that only new content (i.e., content which has not yet been sent to the second user of co-browser device 126), is returned in a response. For example, a timestamp corresponding to the number of milliseconds elapsed since midnight of Jan. 1, 1970 may be used. The timestamp mechanism maintains a timestamp for the latest web page content state on host browser device 100. Whenever new content is sent to co-browser device 126 in a response, a timestamp is also included in the response. Each polling request 706 from co-browser device 126 includes the timestamp of the current web page content at co-browser device 126. The timestamp mechanism compares the current timestamp on host browser device 100 and the received timestamp to accurately determine whether or not the page content on co-browser device 126 needs to be updated. In an operation 726, if no new content needs to be sent back to co-browser device 126, a response indicating no new content is generated.

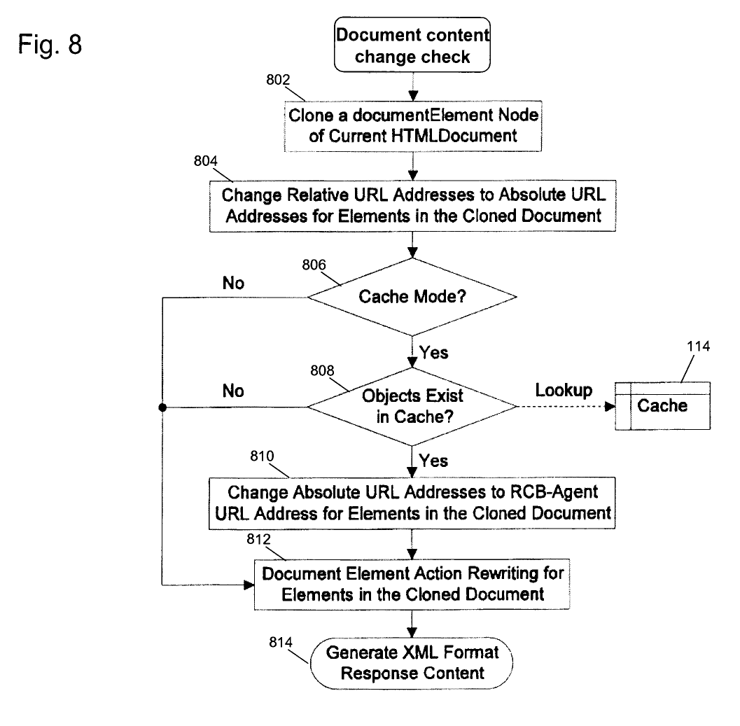

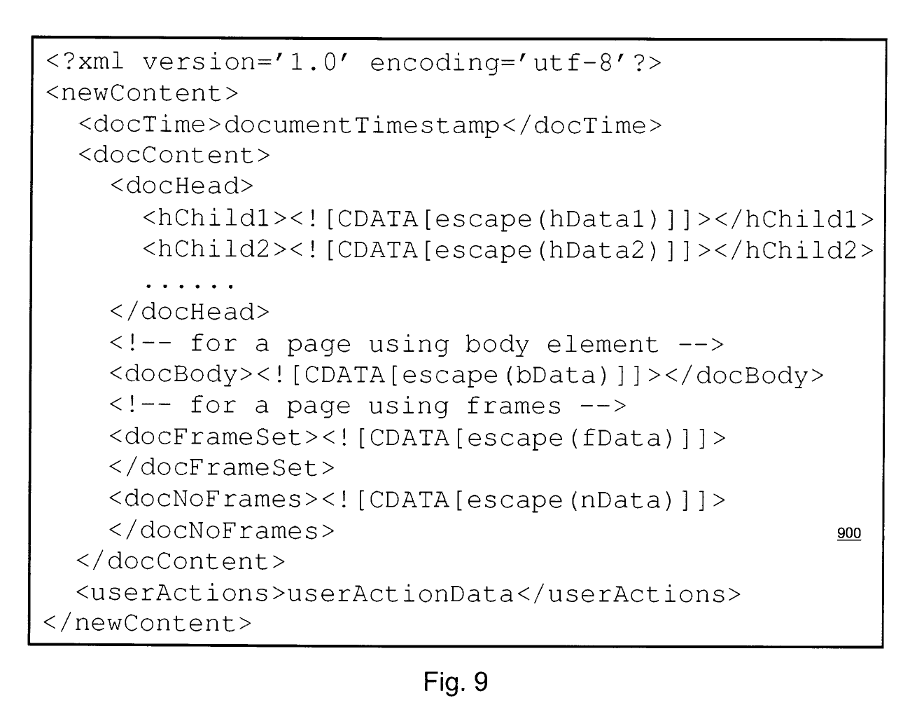

In an operation 728, if there is new content that needs to be sent to co-browser device 126, a response with the new content is generated. Response content generation is explained in greater detail with reference to FIG. 8. To facilitate content parsing in a participant browser, in an operation 730, the new content is sent to co-browser device 126 in the form of an XML document using the “application/xml” type of HTTP response. FIG. 9 shows the XML document in an example embodiment. In an operation 716, an HTTP response to the HTTP request is sent to co-browser device 126.

With reference to FIG. 8, example operations associated with a document content change check procedure performed by browser application 116 and/or collaborative browsing application 118 of FIG. 1 are described. Additional, fewer, or different operations may be performed depending on the embodiment. The order of presentation of the operations of FIG. 8 is not intended to be limiting. The document content change check procedure generates an HTTP response with new content in response to polling request 706 in a form such that co-browser device 126 can efficiently extract and accurately render the content using co-browser application instance 614. To keep track of browsing progress and HTML document changes on host browser application instance 612, a web progress listener object is created which, in an example embodiment, implements the methods of Mozilla's nsl-WebProgressListener interface. To maximize cross-browser compatibility, the standardized W3C Document Object Model Level 2 specification can be used to implement the response content generation functionality.

In an operation 802, a documentElement node (namely the “<html>” root element of an HTML web page) of the current HTMLDocument object is cloned on host browser application instance 612. Subsequent changes are made to the cloned documentElement node (referred to as the cloned document) to avoid any state change to the current document on host browser application instance 612.

In an operation 804, for the supplementary objects of the cloned document, the relative URL addresses are changed to absolute URL addresses of the original web servers to support the non-cache mode because co-browser application instance 614 uses absolute URL addresses to correctly download the supplementary objects from web server 124. To achieve an accurate URL conversion, an observer object is created which implements the methods of Mozilla's nslObserverService. Using the observer object, complete URL addresses can be recorded for the object downloading requests just before the requests are sent out. In an operation 806, a determination is made as to whether or not the cache or non-cache mode is used. In the case of non-cache mode, processing continues at an operation 812.

In the case of cache mode, processing continues at an operation 808. In an operation 808, a determination is made as to whether or not the objects exist in cache 114. If the objects do not exist in cache 114, processing continues at an operation 812. If the objects exist in cache 114 processing continues at an operation 810. In operation 810, for the supplementary objects of the cloned document that exist in the browser cache, their absolute URL addresses are changed to URL addresses associated with the storage in cache 114. When co-browser application instance 614 renders the page content, co-browser application instance 614 automatically sends a “GET” type of HTTP request to collaborative browsing application 118 to retrieve cached objects. Switching between the cache and non-cache modes is fully controlled by collaborative browsing application 118. For example, collaborative browsing application 118 can allow different co-browser devices to use different modes, allow different web pages sent to a particular co-browser device to use different modes, and/or allow different objects on the same web page to use different modes.

In operation 812, event attributes are rewritten for children elements of the cloned document to enable upper-level co-browsing features such as form co-filling and action synchronization. For example, to support the form co-filling feature, the ordered collection of form elements is traversed in the cloned document, and the values of their onsubmit event attributes are changed. More specifically, a call to a specific function residing in collaborative browsing snippet 214 is added to the form onsubmit event handler. When a form is submitted by co-browser application instance 614, the function is called, and the related form data is sent to host browser device 100 in a polling request.

In an operation 814, a new content data block is generated for inclusion in a response to the polling request. In an example embodiment, the new content data block is formatted using XML. From the top-level children of the cloned document, the data object model (DOM) tree is followed in order to process the elements including extracting their attribute name-value lists and innerHTML values. For a typical web page, the cloned document contains two top-level children: a head element and a body element. For web pages using frames, the top-level children include a frameset element and possibly one or more no-frames elements.

With reference to FIG. 9, a sample of a new content data block 900 is shown in accordance with an example embodiment using XML. The newContent element contains a docTime element that carries the document timestamp string, a docContent element that carries the data extracted from the cloned document, and a userActions element that can carry additional browsing action (such as mouse-pointer movement) information. Within the docContent element, for each child element of the cloned document head, its attribute name-value list and innerHTML value are encoded using the JavaScript escape function and carried inside the CDATA section of a corresponding hChild element. For example, hChild1 may contain the data for the title child element of the head, and hChild2 may contain the data for a style element of the head. The contents of these children head elements are separately transmitted so that collaborative browsing snippet 214 can properly and easily update document contents on different types of browser applications. Similarly, the name-value lists and innerHTML values extracted from other top-level children (e.g., body or frameset) of the cloned document are carried in the CDATA sections of their respective elements. The escape encoding function and CDATA section are used to ensure that the response data can be precisely contained in an “application/xml”message and correctly transmitted over network 102. In an example embodiment, the document content change check procedure is executed once for each new document content, and the generated new content data block 900 is reusable for multiple participant browsers.

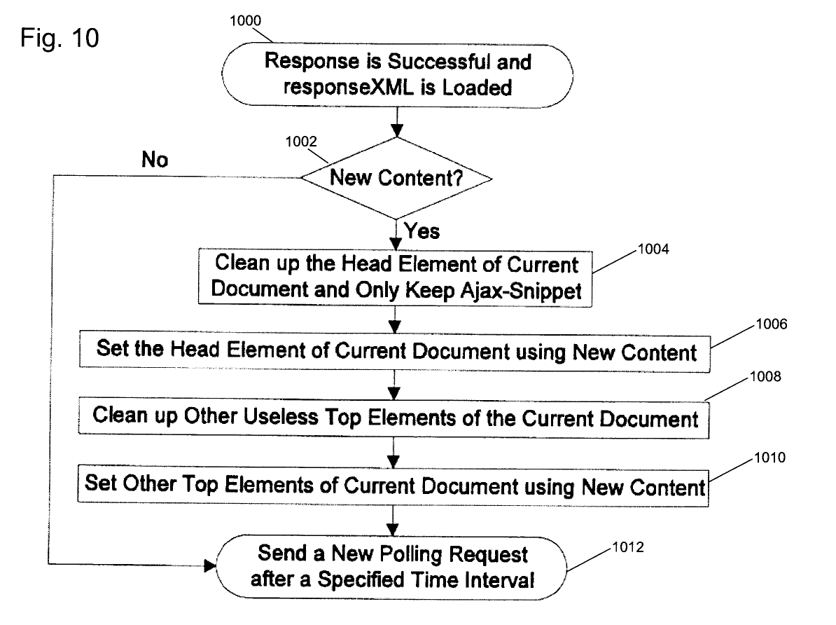

With reference to FIG. 10, example operations associated with a request response processing procedure performed by second browser application 212 and/or collaborative browsing snippet 214 of FIG. 2 are described. Additional, fewer, or different operations may be performed depending on the embodiment. The order of presentation of the operations of FIG. 10 is not intended to be limiting. In an example embodiment, collaborative browsing snippet 214 uses an XMLHttpRequest object to asynchronously exchange data with collaborative browsing application 118. The first polling request is sent after initial HTML page 710 is loaded under control of co-browser application instance 614. Each successive request is triggered after the response to the previous one is received. A new XMLHttpRequest object is created to send each polling request. An onreadystatechange event handler is set for an XMLHttpRequest object to asynchronously process its “readystatechange” events. In an example embodiment, the XMLHttpRequest object uses the POST method so that browsing action information using co-browser application instance 614 can be included in a polling request.

In an example embodiment, in an operation 1000, the request response processing procedure is implemented in the onreadystatechange event handler and is triggered when a response is successful (i.e. HTTP status code sent by collaborative browsing application 118 is 200) and the data transfer has been completed (readyState is DONE and responseXML is loaded) for an XMLHttpRequest. In an operation 1002, a determination is made concerning whether or not new content is included in the response. If collaborative browsing application 118 indicates “no new content” in the responseXML document, processing continues in an operation 1012. If new content is included, processing continues in an operation 1004. In operation 1012, a timeout function such as the JavaScript setTimeout function is used to send a new polling request after a specified time interval. In operation 1004, the current web page document is updated in the document in which it resides using the new content contained in the responseXML document. Example new content can be either a brand new web page or an update to the existing web page.

To simplify the processing logic, the DOM elements of the current document can be updated under control of co-browser application instance 614 in a uniform manner. In an operation 1004, the content of the head element of the current document is cleaned-up, but collaborative browsing snippet 214 is maintained as a “<script>” child element with head 608 of any current document of co-browser application instance 614. For example, as part of the clean-up, the attributes and other children nodes of head 608 of the current document may be removed. In an operation 1006, the attribute name-value list and innerHTML value are extracted from the docHead element of the new content as shown in FIG. 9 and appended to head 608 of the current document. Collaborative browsing snippet 214 may detect a capability of second browser application 212 and execute this operation differently to best accommodate different browser types. For example, because the innerHTML property of the head element is writable using the Firefox browser application, collaborative browsing snippet 214 may directly set the new value for it. In contrast, the innerHTML property is read-only for the head element (and its style child element) using the Internet Explorer browser application, so collaborative browsing snippet 214 may construct each child element of the head element using DOM methods (e.g., createElement and appendChild).

In an operation 1008, the new content is examined and unimportant top-level elements of the current document are removed. For example, if the current document uses a body top-level element while the new content contains a new web page with a frameset top-level element, the body node of the current document is removed. In an operation 1010, other attribute name-value lists and innerHTML values of the current document are set based on the data extracted from the new content following their order in the XML format. The above changes ensure that the web page content presented under control of co-browser application instance 614 is accurately and smoothly synchronized to that presented under control of host browser application instance 612. In an example embodiment, collaborative browsing snippet 214 always resides in co-browser application instance 614 to maintain the communication with collaborative browsing application 118. After updating the current document with the new content, processing continues in operation 1012.

Dynamic DOM changes at host browser device 100 can be synchronized to co-browser device 126. Because collaborative browsing snippet 214 may update the content mainly using innerHTML, the code between a pair of “<script>” and “</script>” tags may not be executed automatically using both the Firefox browser application and the Internet Explorer browser application. However, event handlers previously rewritten by collaborative browsing application 118 can be triggered. The executions of these event handlers in co-browser application instance 614 may not directly update any URL or change the DOM. Instead, collaborative browsing snippet 214 sends action information back to collaborative browsing instance 605. For example, when a hyperlink is selected in co-browser application instance 614, the rewritten onclick event handler may be triggered. The related information is sent back to host browser application instance 612, which performs the selection action and retrieves the new web page from web server 124.

Request authentication can be implemented based on a conventional mechanism of sharing a session secret key and computing the keyed-HashMessage Authentication Code (HMAC). On host browser device 100, a session-specific one-time secret key can be randomly generated and used by collaborative browsing application 118. Host browser device 100 shares the secret key with a participant using an out-of-band mechanism such as a telephone call or instant message. On co-browser device 126, the secret key can be typed in by the second user via a password field on initial HTML page 710 and stored and used by collaborative browsing snippet 214. Before sending a request, collaborative browsing snippet 214 computes an HMAC for the request and appends the HMAC as an additional parameter of the request-URI. After receiving a request sent by collaborative browsing snippet 214, collaborative browsing application 118 computes a new HMAC for the received request (discarding the HMAC parameter) and verifies the new HMAC against the HMAC embedded in the request-URI. The data integrity and the authenticity of a request are assured if these two HMACs are identical. Since the size of a request sent by collaborative browsing snippet 214 is small, an HMAC can be efficiently calculated and any important information in a request can also be efficiently encrypted using a JavaScript implementation. Other security mechanisms can be implemented without limitation.

The word “example” is used herein to mean serving as an example, instance, or illustration. Any aspect or design described herein as “example” is not necessarily to be construed as preferred or advantageous over other aspects or designs. Further, for the purposes of this disclosure and unless otherwise specified, “a” or “an” means “one or more”. The example embodiments may be implemented as a method, apparatus, or article of manufacture using standard programming and/or engineering techniques to produce software, firmware, hardware, or any combination thereof to control a computer to implement the disclosed embodiments.

The foregoing description of example embodiments have been presented for purposes of illustration and of description. It is not intended to be exhaustive or to limit the invention to the precise form disclosed, and modifications and variations are possible in light of the above teachings or may be acquired from practice of the invention. The functionality described may be implemented in a single executable or application or may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A system comprising:
a communication interface configured to receive a connection request from a second device, wherein the connection request indicates a request for a collaborative browsing session between the computing device and the second device;
a processor operably coupled to the communication interface; and
a computer-readable medium operably coupled to the processor, the computer-readable medium having instructions stored thereon that, if executed by the processor, cause the system to perform a method comprising
in response to the received connection request, sending a web page to the second device using the communication interface, wherein the web page includes embedded computer-executable instructions to support the collaborative browsing session;
monitoring a change in state associated with a browser application; and
sending an indicator of the change in state of the browser application to the second device using the communication interface.

2. A computer-readable medium having stored thereon computer-readable instructions that, if executed by a computing device, cause the computing device to perform a method comprising:
receiving a connection request from a second device, wherein the connection request indicates a request for a collaborative browsing session between the computing device and the second device;
in response to the connection request, sending a web page to the second device, wherein the web page includes embedded computer-executable instructions to support the collaborative browsing session;
monitoring a change in state associated with a browser application; and
sending an indicator of the change in state of the browser application to the second device.

3. A method of supporting a collaborative browsing session, the method comprising:
receiving a connection request at a first device from a second device, wherein the connection request indicates a request for a collaborative browsing session between the first device and the second device;
in response to the connection request, sending a web page to the second device from the first device, wherein the web page includes embedded computer-executable instructions to support the collaborative browsing session;
monitoring for a change in state associated with a browser application at the first device; and
sending an indicator of the change in state of the browser application to the second device from the first device.

4. The method of claim 3, further comprising:
sending the connection request to the first device from the second device; and
in response to the connection request, receiving the web page at the second device from the first device.

5. The method of claim 3, further comprising:
sending a polling request to the first device from the second device, wherein the polling request indicates a request for the indicator of the change in state of the browser application;
in response to the polling request, receiving the indicator at the second device from the first device; and
updating a presentation of a second web page at the second device based on the indicator.

6. The method of claim 3, further comprising:
receiving the indicator of the change in state of the browser application from the first device at the second device;
determining from the received indicator if the state of the browser application changed; and
if the state of the browser application is unchanged, sending a polling request to the first device from the second device.

7. The method of claim 6, wherein the polling request is sent after expiration of a timer.

8. The method of claim 6, further comprising:
if the state of the browser application is changed, updating a presentation of a second web page at the second device based on the indicator.

9. The method of claim 6, further comprising:
if the state of the browser application is changed, determining if additional data is needed to update a presentation of a second web page at the second device based on the indicator;
if additional data is needed, sending an object request to the first device from the second device, wherein the object request indicates a request for a cached object associated with the change in state of the browser application;
receiving the cached object from the first device at the second device; and
updating the presentation of the second web page at the second device based on the indicator and the cached object.

10. The method of claim 6, further comprising:
if the state of the browser application is changed, determining if additional data is needed to update a presentation of a second web page at the second device based on the indicator;
if additional data is needed, sending an object request to a third device from the second device, wherein the object request indicates a request for a cached object associated with the change in state of the browser application;
receiving the cached object from the third device at the second device; and
updating the presentation of the second web page at the second device based on the indicator and the cached object.

11. The method of claim 3, further comprising:
receiving an object request from the second device at the first device, wherein the object request indicates a request for a cached object associated with the change in state of the browser application;
identifying the cached object from the object request received at the first device;
reading the identified cached object from a cache at the first device; and
sending the read cached object to the second device from the first device.

12. The method of claim 3, further comprising:
receiving a polling request from the second device at the first device, wherein the polling request indicates a request for the indicator of the change in state of the browser application;
in response to the polling request, generating an update to the web page at the first device; and
sending the generated update to the web page to the second device from the first device.

13. The method of claim 12, wherein generating the update to the web page comprises:
determining if the state of the browser application has changed at the first device; and
if the state of the browser application has not changed, sending a first response indicating no new content to the second device from the first device.

14. The method of claim 13, wherein generating the update to the web page further comprises if the state of the browser application has changed, generating a new content data block; and sending a second response including the new content data block to the second device from the first device.

15. The method of claim 12, wherein the polling request is sent using a hypertext transport protocol POST method.

16. The method of claim 3, wherein the computer-executable instructions are implemented using asynchronous JavaScript and extensible markup language.

17. The method of claim 3, further comprising:
sending a second connection request to a third device from the first device, wherein the second connection request indicates a request for a second collaborative browsing session between the first device and the third device; and
in response to the second connection request, receiving a second web page at the first device from the third device, wherein the second web page includes second embedded computer-executable instructions to support the second collaborative browsing session.

18. The method of claim 17, further comprising:
sending a polling request to the third device from the first device, wherein the polling request indicates a request for a second change in state of a second browser application executing at the third device;
in response to the polling request, receiving a second indicator of the second change in state of the second browser application at the first device from the third device; and
updating a presentation of the second web page at the first device based on the second indicator.

19. The method of claim 18, wherein the polling request includes the indicator of the change in state of the browser application.

20. The method of claim 3, wherein the connection request is sent using a hypertext transport protocol.
